(19) United States
(12) Patent Application Publication
(10) Pub. No.: US 2014/0345533 A1
(43) Pub. Date: Nov. 27, 2014

(54) SENSOR CONTROLLED FOOD AND WATER BOWLS FOR PETS

(71) Applicant: Jim Ray Marentes Aguilar, Albuquerque, NM (US)

(72) Inventor: Jim Ray Marentes Aguilar, Albuquerque, NM (US)

(21) Appl. No.: 13/899,667

(22) Filed: May 22, 2013

(51) Int. Cl. A01K 5/02; A01K 7/02

(52) U.S. Cl. CPC A01K 5/02; A01K 7/02
USPC 119/51.02; 119/61.5; 119/51.5

(57) ABSTRACT

A sensor controlled food and water system and method for pet animals. A collar of a pet animal can be attached to a sensor for selectively operating one or more bowls allocated to the pet animal. The bowl for storing the food and/or water can be linked with the sensor such that the lid of the bowl opens on detecting the presence of the pet animal near the bowl. Each animal can be provided with a collar having a sensor and a bowl linked with and/or which communicates wirelessly with the sensor (e.g., RFID tags). The lid of the bowl allocated to the animal opens when the pet is near the bowl and closes when the pet is at a distal or particular location from the bowl.

### CROSS-REFERENCE TO PROVISIONAL APPLICATION

This patent application claims the benefit under 35 U.S.C. §119(e) of U.S. Provisional Application Ser. No. 61/562,413 entitled, “Sensor Controlled Food and Water Bowls for Pets,” which was filed on May 29, 2012 and is incorporated herein by reference in its entirety.

### FIELD OF THE INVENTION

Embodiments are generally related to food and water bowls for pet animals. Embodiments also relate to the field of system and method for controlling access of food and water for pet animals. Embodiments additionally relate to sensor controlled food and water bowls for pet animals such as dogs and cats.

### BACKGROUND

Domestic companion animals, particularly dogs and cats, are very popular among pet owners. Control of such animals is performed with mechanical arrangements such as fences, gates, corrals, pens, and the like. Electrical means for control of animals has been provided with electrified fences. Animal feeding and watering devices are responsive to animal actions such as mechanical arrangements for dispensing food and water when an animal depresses a valve mechanism such as with a water fountain. Such prior art arrangements do not utilize automatic control nor selective control, where the animal provides the actuator control and the valve will operate for any animal depressing the valve mechanism.

In some instances, a cat owner may provide food for a pet, but the food may be consumed by other cats. In another application, a rancher may provide water, grain, or salt for his cattle which may be consumed by other cattle or wild animals that have access to the range. Multitudes of other examples are well known where food and drink are provided for particular animals, but which may be consumed by other animals because of the non-selective nature of the container or dispenser.

The prior art does not show automatic control of animals on a selective bases nor an arrangement for selectively responding to animals for providing a desired operation such as feeding or providing access for a selected animal.

When a pet owner has two dogs, and one dog had some teeth removed, then such teeth removed dog should be provided with a special diet for a while and has to be kept separate from other dog. Also, some pet animals may be on a special diet for safety reasons, or might be recovering from an operation and needs medicine added to their food. This harms other animals when they consume such special diet food. Therefore, a need exists for a system that allows access to food and drinks on a selected basis. Also, such system should allow pet animals to consume the food allocated to them.

### SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide food and water bowls for pet animals.

It is a further aspect of the present invention to provide for a system and method for controlling access of food and water of pet animals.

It is another aspect of the present invention to provide for a sensor controlled food and water bowls for pet animals such as dogs and cats.

The aforementioned aspects and other objectives and advantages can now be achieved as described herein. A sensor controlled food and water bowls for pet animals is disclosed. A collar of a pet animal is attached with a sensor for selectively operating at least one bowl allocated to the pet animal. The bowl for storing the food and water is linked with the sensor such that the lid of the bowl opens on detecting the presence of the pet animal at the proximity of the bowl. Each animal can have a collar with a sensor and a bowl linked with the sensor. The lid of the bowl allocated to the animal opens when the pet is at the proximity of the bowl and closes when the pet is at the distal location. When pet animal owner has more than one pet, each can have the food allocated to them without eating each other's food. Also each pet can be maintained separately.

When an animal is on a special diet for safety reasons or recovering from an operation and needs medicine added to their food, the present invention will not harm other pet animals. Also, the bowl will protect the food/water from the other animals like rats, birds, and ants when the owners are away. The bowl may be used inside or outside the house and can have many variations such as images of football teams and other patterns.

The present invention also acts as a feeder for pet animals such that the pet owners do not have to refill the food constantly when they are on vacation. Also, the lids can be of a solid color to protect it from the sun radiation.

Based on the foregoing, it can be appreciated that a number of embodiments, preferred and alternative, are disclosed herein. In one embodiment, for example, a sensor controlled food and water system for pet animals can be implemented. Such a system can include, for example, at least one sensor attached to a collar of at least one pet animal; at least one bowl for storing food and/or water for the at least one pet animal, the at least one bowl comprising a lid and a lid operating mechanism, wherein the at least one bowl is linked with the at least one sensor such that the lid opens on detecting a presence of the at least one pet animal in a location near and/or proximate to the at least one bowl; a transmitter attached to the collar for transmitting a signal from the at least one sensor to the at least one bowl; a receiver attached to the at least one bowl for receiving the signal from the transmitter; and a processor attached to the at least one bowl for processing the signal from the receiver and converting the signal to operate the lid operating mechanism.

In some embodiments, the lid operating mechanism automatically opens the lid when the at least one pet animal is located proximate to the at least one bowl. In other embodiments (or the same embodiment), the lid operating mechanism can close the lid when the at least one pet animal is at a distal location with respect to the at least one bowl. In yet another embodiment, the at least one bowl can protect the food and/or water from other pet animals and allows only the at least one pet animal having the at least one sensor and the collar to consume the food and/or water allocated to the at least one pet animal via the at least one bowl. In still other embodiments, the at least one bowl can be painted or covered with a solid color to protect the at least one bowl from sun radiation.

In another embodiment, the lid operating mechanism automatically opens the lid when the at least one pet animal is located proximate to the at least one bowl and the lid operating mechanism automatically closes the lid when the at least one pet animal is at a distal location with respect to the at least one bowl. In still other embodiments, the at least one bowl protects the food and/or water from other pet animals and allows only the at least one pet animal having the at least one sensor and the collar to consume the food and/or water allocated to the at least one pet animal via the at least one bowl.

In another embodiment, a sensor controlled food and water system for pet animals can be implemented. Such a system can include at least one sensor attached to a collar of at least one pet animal; and at least one bowl for storing food and/or water for the at least one pet animal, the at least one bowl comprising a lid and a lid operating mechanism, wherein the at least one bowl is linked (e.g., RFIG tag, wireless communications, etc.) with the at least one sensor such that the lid opens on detecting a presence of the at least one pet animal in a location near and/or proximate to the at least one bowl.

In yet another embodiment, such a system can include a transmitter attached to the collar for transmitting a signal from the at least one sensor to the at least one bowl and a receiver attached to the at least one bowl for receiving the signal from the transmitter. In still another embodiment, a processor can be connected and/or attached to the at least one bowl for processing the signal from the receiver and converting the signal to operate the lid operating mechanism. In other embodiments, the lid operating mechanism automatically opens the lid when the at least one pet animal is located proximate to the at least one bowl. In other embodiments, the lid operating mechanism automatically closes the lid when the at least one pet animal is at a distal location with respect to the at least one bowl. In still other embodiments, the at least one bowl protects the food and/or water from other pet animals and allows only the at least one pet animal having the at least one sensor and the collar to consume the food and/or water allocated to the at least one pet animal via the at least one bowl.

In another embodiment, a sensor controlled food and water method for pet animals can be implemented. Such a method can include the steps of, for example: attaching at least one sensor to a collar of at least one pet animal; providing at least one bowl for storing food and/or water for the at least one pet animal, the at least one bowl comprising a lid and a lid operating mechanism, wherein the at least one bowl is linked with the at least one sensor such that the lid opens on detecting a presence of the at least one pet animal in a location near and/or proximate to the at least one bowl; connecting a transmitter to the collar for transmitting a signal from the at least one sensor to the at least one bowl; attaching a receiver to the at least one bowl for receiving the signal from the transmitter; and connecting a processor to the at least one bowl for processing the signal from the receiver and converting the signal to operate the lid operating mechanism.

### BRIEF DESCRIPTION OF THE FIGURES

The accompanying figures, in which like reference numerals refer to identical or functionally-similar elements throughout the separate views and which are incorporated in and form a part of the specification, further illustrate the disclosed embodiments and, together with the detailed description of the invention, serve to explain the principles of the disclosed embodiments.

FIG. 1 illustrates a block diagram of a sensor controlled food and water system for pet animals, in accordance with the disclosed embodiments;

FIG. 2 illustrates a schematic diagram of a sensor controlled food and water system for a cat and dogs, in accordance with the disclosed embodiments;

FIG. 3 illustrates a schematic diagram of a sensor controlled food and water system for a cat and dogs showing the cat consuming the food allocated to it in a bowl, in accordance with the disclosed embodiments;

FIG. 4 illustrates a schematic diagram of a sensor controlled food and water system for a cat and dogs showing the dogs consuming the food allocated to them in a single bowl, in accordance with the disclosed embodiments;

FIG. 5 illustrates a schematic diagram of a sensor controlled food and water system for a cat and dogs showing separate bowl for a cat and dogs, in accordance with the disclosed embodiments; and

FIG. 6 illustrates a high level flow chart depicting a process of controlling access of each pet animals such that the each pet consumes the food allocated to them, in accordance with the disclosed embodiment.

### DETAILED DESCRIPTION

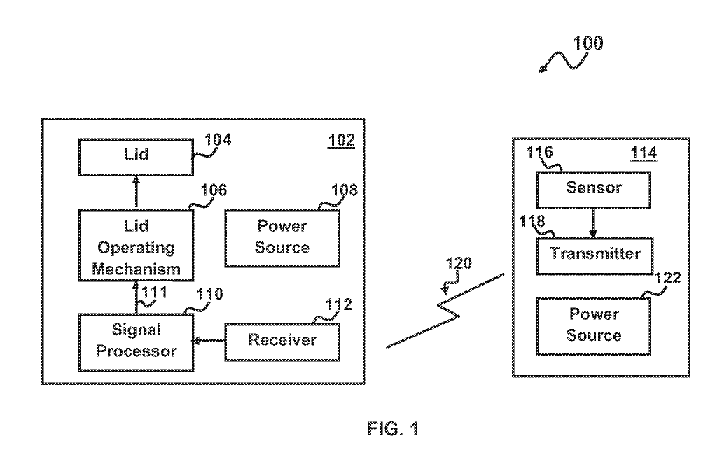

The particular values and configurations discussed in these non-limiting examples can be varied and are cited merely to illustrate at least one embodiment and are not intended to limit the scope thereof. Note that in FIGS. 1-5, identical or similar parts or elements are generally indicated by identical reference numerals.

The embodiments will now be described more fully hereinafter with reference to the accompanying drawings in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly defined herein.

FIG. 1 illustrates a block diagram of a sensor controlled food and water system 100 for pet animals, in accordance with the disclosed embodiments. The system 100 has a sensor 116 attached to a collar 114 of a pet animal and a bowl 102 for storing food and water for pet animals. The bowl 102 generally includes a lid 104 and a lid operating mechanism 106. The bowl 102 is linked with the sensor 116 such that the lid 104 opens on detecting the presence of pet animal near the proximity of the bowl 102. A transmitter 118 attached to the collar 114 transmits a signal 120 from the sensor 116 to the bowl 102. A receiver 112 attached to the bowl 102 receives the signal 120 from the collar 114. A signal processor 110 processes the signal 120 and converts to a lid-operating signal 111 for operating the lid operating mechanism 106. The lid operating mechanism 106 opens the lid 104 when the pet animal is near proximity of the bowl 102 and closes the lid 104 when the pet animal is at distal location from the bowl 102. The bowl 102 and collar 114 are powered by utilizing power sources 108 and 122.

Note that the receiver 112 receives signal from the transmitter 118 only when the pet animal is near the proximity of the bowl 102. This operates the lid operating mechanism 106 to open the lid 104 for the pet animal to consume the food allocated to it. The receiver 112 does not receive any signal from transmitter 118 when the pet animal is at the distal location and hence the lid operating mechanism 106 keeps the lid 104 of the bowl 102 closed.

Each animal has a sensor 116 in its collar 114 and a bowl 102 linked with the collar 114. Such bowl 102 protects the food and water from other animals and allows only the pet animal having the sensor 116 and the associated bowl 102 to consume the food and water allocated to it. Top of the lid 104 is coated with a solid color to protect the bowl 102 from sun radiation. The bowl 102 protects the food and water from other animals like rats, birds, ants, etc., when the pet owner is away.

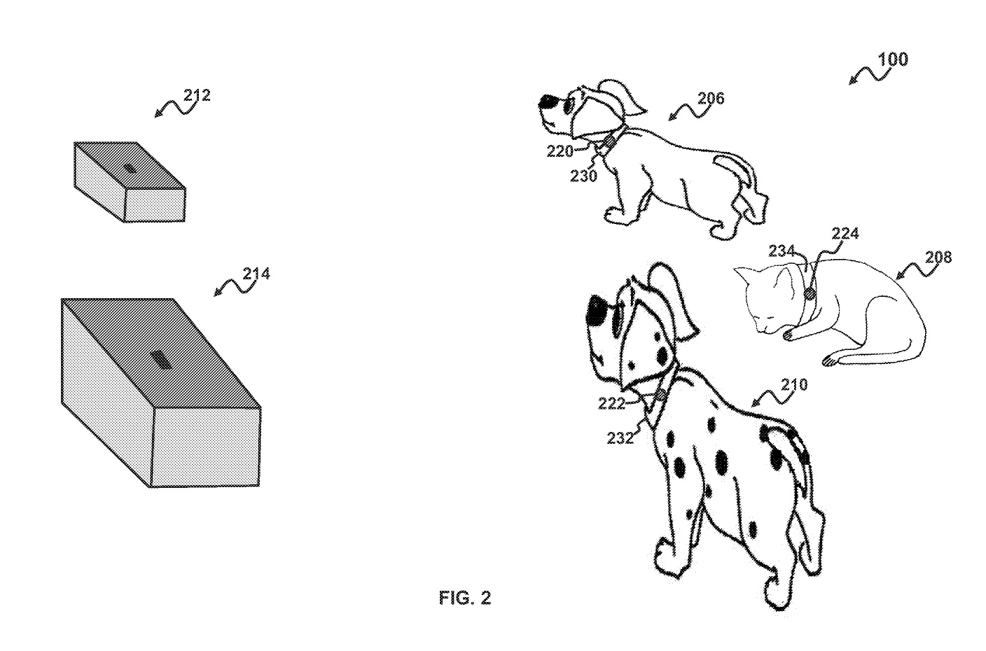

FIG. 2 illustrates a schematic diagram of a sensor controlled food and water system 100 for a cat and dogs, in accordance with the disclosed embodiments. The bowl 212 is allocated to the cat 208 and a bowl 214 is allocated to the dogs 206 and 210. The dogs 206 and 210 share the food in the bowl 214. The cat 208 has a sensor 224 attached to its collar 234. The bowl 212 opens when the cat 208 is near the proximity of the bowl 212. The dogs 206 and 210 have sensors 220 and 222 attached to their collars 230 and 232, respectively. The bowl 214 opens when at least one dog is near the proximity of the bowl 214.

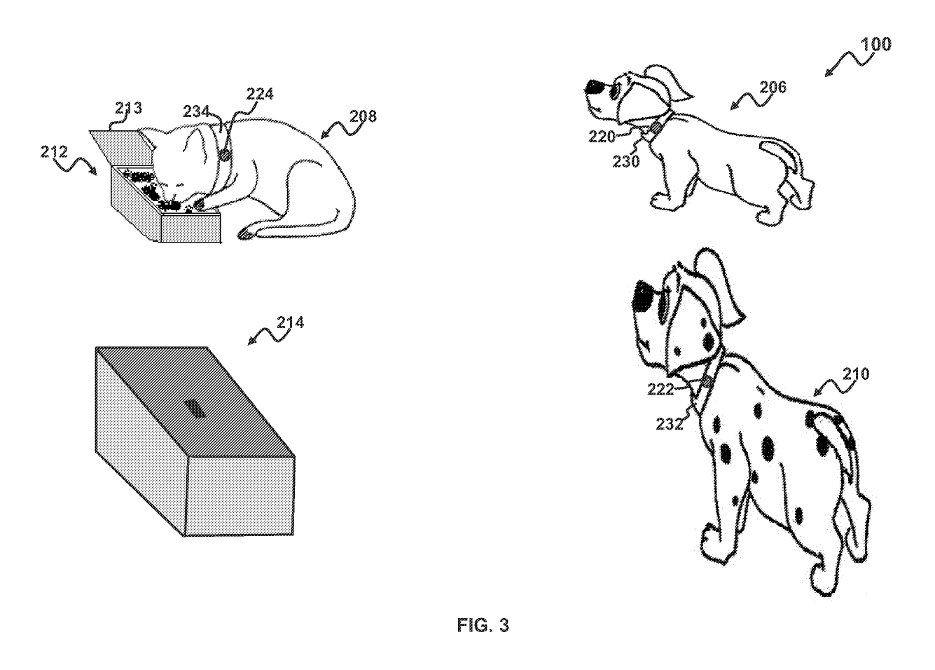

FIG. 3 illustrates a schematic diagram of a sensor controlled food and water system 100 for the cat 208 and dogs 206 and 210 depicted in FIG. 2, showing the cat 208 consuming the food allocated to it in the bowl 212, in accordance with the disclosed embodiments. The lid 213 opens when the cat 208 is near the proximity of the bowl 212 and closes when the cat 208 is at the distal location of the bowl 212.

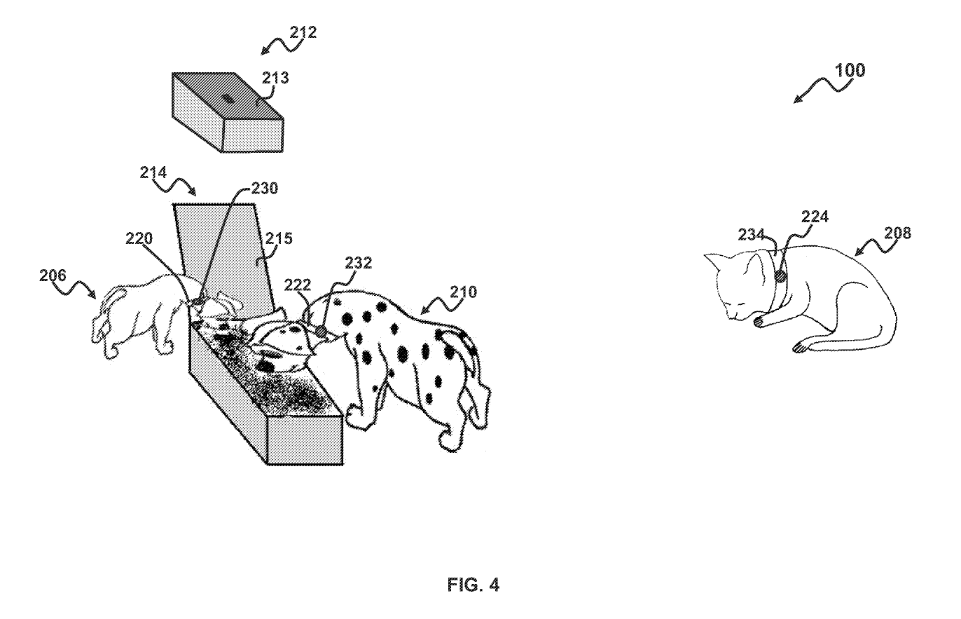

FIG. 4 illustrates a schematic diagram of a sensor controlled food and water system 100 for the cat 208 and dogs 206 and 210 depicted in FIG. 2, showing the dogs 206 and 210 consuming the food allocated to them in a single bowl 214, in accordance with the disclosed embodiments. The lid 215 opens when the dogs 206 and 210 are near the proximity of the bowl 214 and closes when the dogs 206 and 210 are at the distal location of the bowl 214.

Note that the bowl allocated to a pet animal opens and allows the pet animal to consume the food only when the pet animal is near the proximity of the bowl. Also, such bowl closes and does not allow the pet animals to consume the food when the pet animal is at the distal location from the bowl. The sensor attached to the collar of the pet animal is linked with the bowl allocated to it. Based on the signal transmitted from the sensor of each pet animal, the system decides whether the pet animal is near the proximity or at the distal location of the bowl.

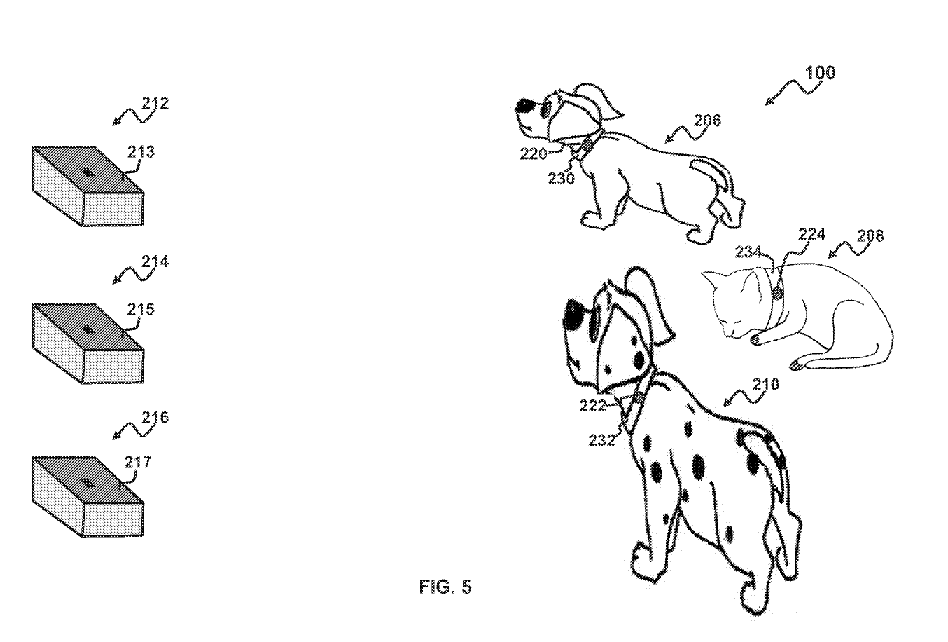

FIG. 5 illustrates a schematic diagram of a sensor controlled food and water system 100 for a cat 208 and dogs 206 and 210 showing a separate bowl for each pet animal, in accordance with the disclosed embodiments. The dogs 206 and 210 consume the food allocated in the bowls 212 and 216 respectively and the cat 208 consumes the food allocated in the bowl 214. On requirement of food, the dogs 206 and 210 and cat 208 moves towards their allocated or trained bowls 212, 216, and 214, respectively. When the dog 206 is near the proximity of the bowl 212, the lid 213 opens and the dog 206 can consume its food in the bowl 212. When the dog 210 is near the proximity of the bowl 216, the lid 217 opens and the dog 210 can consume its food in the bowl 216. Similarly, the lid 215 opens and the cat 208 can consume the food allocated in the bowl 214, when it moves near the proximity of the bowl 214.

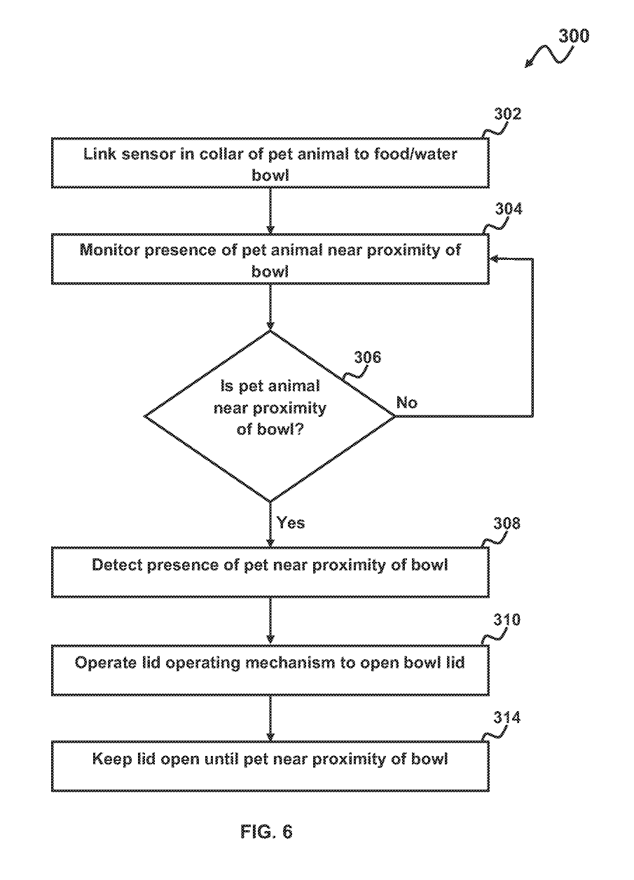

FIG. 6 illustrates a high level flow chart 300 depicting a process of controlling access of each pet animals such the each pet consumes the food allocated to them by utilizing the system 100 depicted in FIG. 1, in accordance with the disclosed embodiment. One or more pet animals each having a sensor in their collar is linked to a food and water bowl, as depicted at block 302. The presence of the pet animal near the proximity of allocated bowl is monitored, as indicated at block 304. As illustrated at block 306, the system 100 depicted in FIG. 1 checks whether the pet animal is near the proximity of the allocated bowl. If the pet animal is near the proximity of the allocated bowl, its presence is detected as depicted at block 308 else the system 100 depicted in FIG. 1 monitors the presence of the pet animal near the proximity of the bowl as depicted at block 304. Note that the presence of the pet animal near the proximity of the bowl is detected only when the bowl receives signal from the sensor. On detecting the presence of pet animal near the proximity of the bowl, the lid open mechanism opens the bowl lid as illustrated at block 310. Finally, the lid is kept opened until the pet animal is near the proximity of the bowl and the bowl closes once the pet animal is moved to distal location as illustrated at block 314.

Based on the foregoing, it can be appreciated that a number of embodiments, preferred and alternative, are disclosed herein. In one embodiment, for example, a sensor controlled food and water system for pet animals can be implemented. Such a system can include, for example, at least one sensor attached to a collar of at least one pet animal; at least one bowl for storing food and/or water for the at least one pet animal, the at least one bowl comprising a lid and a lid operating mechanism, wherein the at least one bowl is linked with the at least one sensor such that the lid opens on detecting a presence of the at least one pet animal in a location near and/or proximate to the at least one bowl; a transmitter attached to the collar for transmitting a signal from the at least one sensor to the at least one bowl; a receiver attached to the at least one bowl for receiving the signal from the transmitter; and a processor attached to the at least one bowl for processing the signal from the receiver and converting the signal to operate the lid operating mechanism.

In some embodiments, the lid operating mechanism automatically opens the lid when the at least one pet animal is located proximate to the at least one bowl. In other embodiments (or the same embodiment), the lid operating mechanism can close the lid when the at least one pet animal is at a distal location with respect to the at least one bowl. In yet another embodiment, the at least one bowl can protect the food and/or water from other pet animals and allows only the at least one pet animal having the at least one sensor and the collar to consume the food and/or water allocated to the at least one pet animal via the at least one bowl. In still other embodiments, the at least one bowl can be painted or covered with a solid color to protect the at least one bowl from sun radiation.

In another embodiment, the lid operating mechanism automatically opens the lid when the at least one pet animal is located proximate to the at least one bowl and the lid operating mechanism automatically doses the lid when the at least one pet animal is at a distal location with respect to the at least one bowl. In still other embodiments, the at least one bowl protects the food and/or water from other pet animals and allows only the at least one pet animal having the at least one sensor and the collar to consume the food and/or water allocated to the at least one pet animal via the at least one bowl.

In another embodiment, a sensor controlled food and water system for pet animals can be implemented. Such a system can include at least one sensor attached to a collar of at least one pet animal; and at least one bowl for storing food and/or water for the at least one pet animal, the at least one bowl comprising a lid and a lid operating mechanism, wherein the at least one bowl is linked (e.g., RFIG tag, wireless communications, etc.) with the at least one sensor such that the lid opens on detecting a presence of the at least one pet animal in a location near and/or proximate to the at least one bowl.

In yet another embodiment, such a system can include a transmitter attached to the collar for transmitting a signal from the at least one sensor to the at least one bowl and a receiver attached to the at least one bowl for receiving the signal from the transmitter. In still another embodiment, a processor can be connected and/or attached to the at least one bowl for processing the signal from the receiver and converting the signal to operate the lid operating mechanism. In other embodiments, the lid operating mechanism automatically opens the lid when the at least one pet animal is located proximate to the at least one bowl. In other embodiments, the lid operating mechanism automatically doses the lid when the at least one pet animal is at a distal location with respect to the at least one bowl. In still other embodiments, the at least one bowl protects the food and/or water from other pet animals and allows only the at least one pet animal having the at least one sensor and the collar to consume the food and/or water allocated to the at least one pet animal via the at least one bowl.

In another embodiment, a sensor controlled food and water method for pet animals can be implemented. Such a method can include the steps of, for example: attaching at least one sensor to a collar of at least one pet animal; providing at least one bowl for storing food and/or water for the at least one pet animal, the at least one bowl comprising a lid and a lid operating mechanism, wherein the at least one bowl is linked with the at least one sensor such that the lid opens on detecting a presence of the at least one pet animal in a location near and/or proximate to the at least one bowl; connecting a transmitter to the collar for transmitting a signal from the at least one sensor to the at least one bowl; attaching a receiver to the at least one bowl for receiving the signal from the transmitter; and connecting a processor to the at least one bowl for processing the signal from the receiver and converting the signal to operate the lid operating mechanism.

It will be appreciated that variations of the above disclosed apparatus and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A sensor controlled food and water system for pet animals, said system comprising:
at least one sensor attached to a collar of at least one pet animal;
at least one bowl for storing food and/or water for said at least one pet animal, said at least one bowl comprising a lid and a lid operating mechanism, wherein said at least one bowl is linked with said at least one sensor such that said lid opens on detecting a presence of said at least one pet animal in a location near and/or proximate to said at least one bowl;
a transmitter attached to said collar for transmitting a signal from said at least one sensor to said at least one bowl;
a receiver attached to said at least one bowl for receiving said signal from said transmitter; and
a processor attached to said at least one bowl for processing said signal from said receiver and converting said signal to operate said lid operating mechanism.

2. The system of claim 1 wherein said lid operating mechanism automatically opens said lid when said at least one pet animal is located proximate to said at least one bowl.

3. The system of claim 1 wherein said lid operating mechanism automatically closes said lid when said at least one pet animal is at a distal location with respect to said at least one bowl.

4. The system of claim 1 wherein said at least one bowl protects said food and/or water from other pet animals and allows only said at least one pet animal having said at least one sensor and said collar to consume said food and/or water allocated to said at least one pet animal via said at least one bowl.

5. The system of claim 1 wherein said at least one bowl comprises a solid color to protect said at least one bowl from sun radiation.

6. The system of claim 1 wherein said lid operating mechanism automatically opens said lid when said at least one pet animal is located proximate to said at least one bowl, and said lid operating mechanism automatically closes said lid when said at least one pet animal is at a distal location with respect to said at least one bowl.

7. The system of claim 6 wherein said at least one bowl protects said food and/or water from other pet animals and allows only said at least one pet animal having said at least one sensor and said collar to consume said food and/or water allocated to said at least one pet animal via said at least one bowl.

8. The system of claim 6 wherein said at least one bowl comprises a solid color to protect said at least one bowl from sun radiation.

9. A sensor controlled food and water system for pet animals, said system comprising:
at least one sensor attached to a collar of at least one pet animal; and
at least one bowl for storing food and/or water for said at least one pet animal, said at least one bowl comprising a lid and a lid operating mechanism, wherein said at least one bowl is linked with said at least one sensor such that said lid opens on detecting a presence of said at least one pet animal in a location near and/or proximate to said at least one bowl.

10. The system of claim 9 further comprising:
a transmitter attached to said collar for transmitting a signal from said at least one sensor to said at least one bowl; and
a receiver attached to said at least one bowl for receiving said signal from said transmitter.

11. The system of claim 10 further comprising a processor attached to said at least one bowl for processing said signal from said receiver and converting said signal to operate said lid operating mechanism.

12. The system of claim 11 wherein said lid operating mechanism automatically opens said lid when said at least one pet animal is located proximate to said at least one bowl.

13. The system of claim 11 wherein said lid operating mechanism automatically closes said lid when said at least one pet animal is at a distal location with respect to said at least one bowl.

14. The system of claim 11 wherein said at least one bowl protects said food and/or water from other pet animals and allows only said at least one pet animal having said at least one sensor and said collar to consume said food and/or water allocated to said at least one pet animal via said at least one bowl.

15. A sensor controlled food and water method for pet animals, said method comprising:
attaching at least one sensor to a collar of at least one pet animal;
providing at least one bowl for storing food and/or water for said at least one pet animal, said at least one bowl comprising a lid and a lid operating mechanism, wherein said at least one bowl is linked with said at least one sensor such that said lid opens on detecting a presence of said at least one pet animal in a location near and/or proximate to said at least one bowl;
connecting a transmitter to said collar for transmitting a signal from said at least one sensor to said at least one bowl;
attaching a receiver to said at least one bowl for receiving said signal from said transmitter; and
connecting a processor to said at least one bowl for processing said signal from said receiver and converting said signal to operate said lid operating mechanism.

16. The method of claim 15 wherein said lid operating mechanism automatically opens said lid when said at least one pet animal is located proximate to said at least one bowl.

17. The method of claim 15 wherein said lid operating mechanism automatically closes said lid when said at least one pet animal is at a distal location with respect to said at least one bowl.

18. The method of claim 15 wherein said at least one bowl protects said food and/or water from other pet animals and allows only said at least one pet animal having said at least one sensor and said collar to consume said food and/or water allocated to said at least one pet animal via said at least one bowl.

19. The method of claim 15 wherein said at least one bowl comprises a solid color to protect said at least one bowl from sun radiation.

20. The method of claim 15 wherein said lid operating mechanism automatically opens said lid when said at least one pet animal is located proximate to said at least one bowl and said lid operating mechanism automatically closes said lid when said at least one pet animal is at a distal location with respect to said at least one bowl.
